(19) United States
(12) Patent Application Publication
(10) Pub. No.: US 2007/0163858 A1
(43) Pub. Date: Jul. 19, 2007

(54) Snow collection and transportation system

(76) Inventor: Wilhelm Leitner, Vernon (CA)

Correspondence Address: ANTONY C. EDWARDS, SUITE 200 - 270 HIGHWAY 33 WEST, KELOWNA, BC, V1X 1X7, CA

(21) Appl. No.: 11/654,502

(22) Filed: Jan. 18, 2007

Related U.S. Application Data
(60) Provisional application No. 60/759,611, filed on Jan. 18, 2006.

(51) Int. Cl. B65G 11/00

(52) U.S. Cl. 193/3

(57) ABSTRACT

A method for collecting and transporting snow includes the steps of providing a snow collector mounted to an inclined alpine mountain-side and a pipe cooperating with the snow collector to remove snow from the snow collector to a downhill location remote from the snow collector, collecting snow in the snow collector and diverting snow from the snow collector into the pipe, transporting the snow downhill in the pipe, and delivering the snow from the pipe at the downhill location below the elevation of the snow collector.

### CROSS REFERENCE TO RELATED APPLICATION

This application claims priority from U.S. Provisional Patent Application No. 60/759,611 filed Jan. 18, 2006 entitled Snow Collection and Transportation System.

### FIELD OF THE INVENTION

This invention relates to the field of devices for assisting the amount of snow available on ski runs at ski resorts and in particular to a snow gathering and transport mechanism for use in high alpine locations.

### BACKGROUND OF THE INVENTION

It is a common problem for ski resorts that they have insufficient snow to form an adequate base for use by skiers so as to cover obstacles such as rocks, shrubs and the like especially when the ski resort or particular runs on a ski resort are very popular, the crowd of skiers typically then scraping off any fresh snow and reducing the base until obstacles are exposed. The problem is exacerbated by the locating of ski resorts at relatively low elevation so as to be easily accessible by the public and so as to keep the operating temperature during the winter at the resort in a range below freezing which does not get too cold so as to discourage use by the public.

In the past, it is known to employ so-called snow making machinery which essentially vaporizes water under pressure through a blower mechanism so as to create ice crystals as the vaporized water is sprayed over the ski slope. This requires a large source of water which must be pumped through a system of pipes and often requires the actual blower mechanism to be systematically relocated so as to distribute the freshly made snow over what is typically quite a large ski run area on a resort.

In the prior art applicant is aware of the following United States Patents:

U.S. Pat. No. 5,199,198, which issued Apr. 6, 1993 to Godbout for an Apparatus and Method for Snow Disposal, discloses a method of disposing of snow through manholes. The snow is collected in a bin positioned over a manhole. The bin may be coated with a suitable slippery substance to prevent the snow from adhering to it. Alternatively, the walls of the bin may be vibrated. At or near the base of the bin, the snow is ground and then projected into the manhole.

U.S. Pat. No. 4,307,975, which issued Dec. 29, 1981 to Heitman for a Water Flow Control System discloses a system for controlling the flow of surface water on a hillside. The system is comprised of a network of conducting channels.

U.S. Pat. No. 5,211,511, which issued May 18, 1993 to Deal, Jr. for a Slurry Distribution System Using Remote Distributors discloses a method of distributing slurry over a large area using aerial projectors. The slurry is pumped through an array of conduits. The distribution of the slurry is accurately regulated and controlled.

U.S. Pat. No. 6,692,186, which issued Feb. 17, 2004 to Suazo et al. for an Apparatus and Method for Transporting Water discloses the use of corrugated polyethylene conduits to direct the flow of water through ditches.

U.S. Pat. No. 4,561,801, which issued Dec. 31, 1985 to Nantz for a Method and Apparatus for Inhibiting Erosion discloses the use of troughs to remove runoff from a hillside in a manner effective to prevent soil erosion.

U.S. Pat. No. 5,672,028, which issued Sep. 30, 1997 to Mehta for a Flood Control System discloses the use of culverts to move water from areas of higher elevation to areas of lower elevation. It is used to remove water from the area in the median between divided lanes of a highway.

### SUMMARY OF THE INVENTION

The present invention is a system for transporting snow from areas of higher elevation to areas of lower elevation. The system is intended to be used at an alpine or Nordic skiing facility to provide a supply of snow to areas which have received an inadequate amount. The system consists of an upper catchment area, a channelling system which may be of PVC piping and a lower distribution area. At the upper catchment area, the snow is collected on large sheets of a material such as corrugated fibreglass. The sheets are on a slope. The snow that either falls or is blown onto these sheets slides by gravity towards and into the PVC piping and then down the piping to the distribution area. Once at the distribution area, the snow may be directed by a series of smaller diameter piping, by incorporating some form of pivot in the lower end of the piping, or simply by using snow blowers or snow grooming equipment.

In summary, the present invention may be characterized in one aspect as a method and apparatus for collecting and transporting snow comprising the apparatus elements and the steps of:
a) collecting snow in a snow collector mounted to an inclined alpine mountain-side,
b) diverting snow from the snow collector into a pipe,
c) transporting the snow downhill in the pipe,
d) delivering the snow from the pipe at a lower elevation below the elevation of the snow collector for use of the snow for recreation at the lower elevation.

The method and apparatus may further comprise the step of mounting the snow collector to the alpine mountainside so that a snow collecting catchment surface of the snow collector is inclined and thereby urges snow collecting in the collector towards a snow diverter cooperating with a downhill side of the snow collector.

The method and apparatus may further comprise the steps of providing a corrugated-shaped surface for use as the snow collector and aligning troughs or channels of the surface so as to be elongate in a substantially downhill direction.

### BRIEF DESCRIPTION OF THE DRAWINGS

FIG. 1 is, in perspective view, the snow collection and transportation system according to one embodiment of the present invention mounted on a mountain-side.

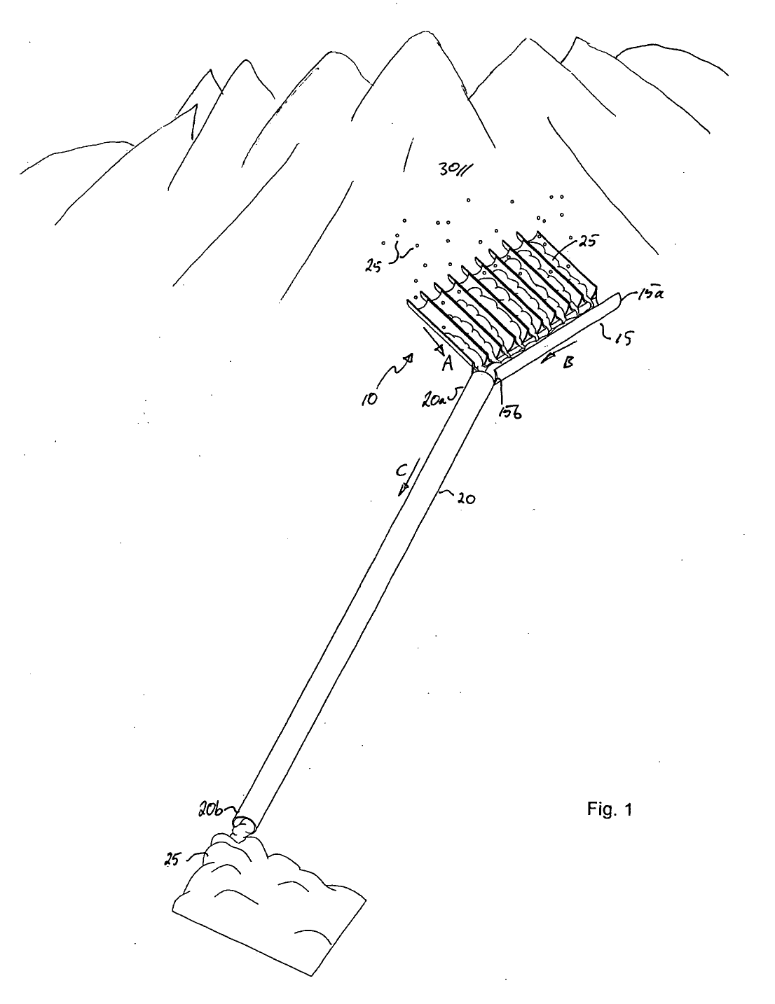

FIG. 2 is an enlarged view of the snow collecting portion of the system of FIG. 1.

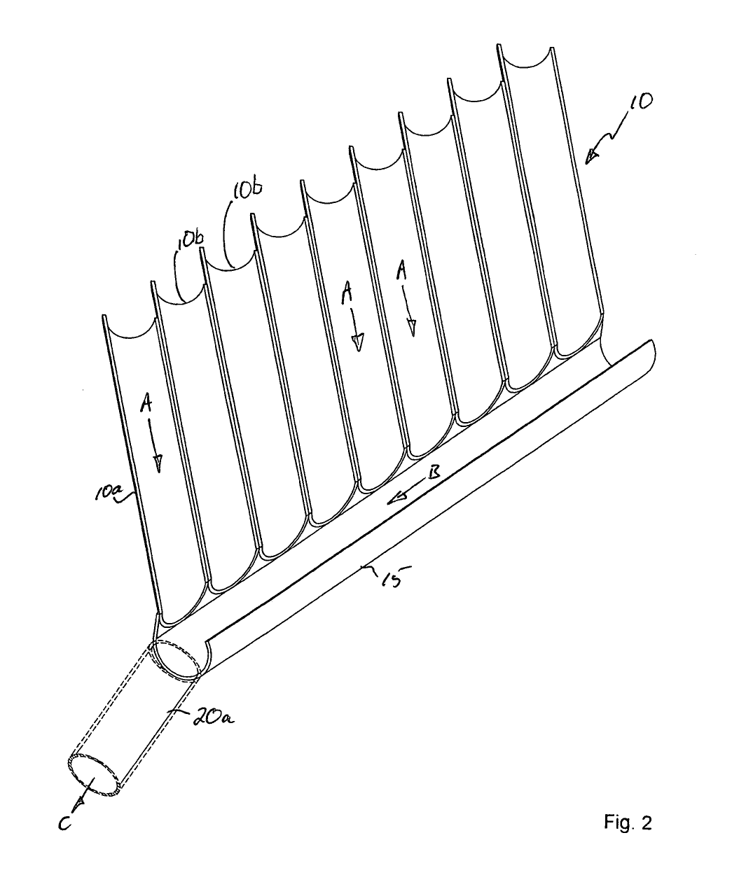

FIG. 3 is an under side perspective view of the snow collector of FIG. 2.

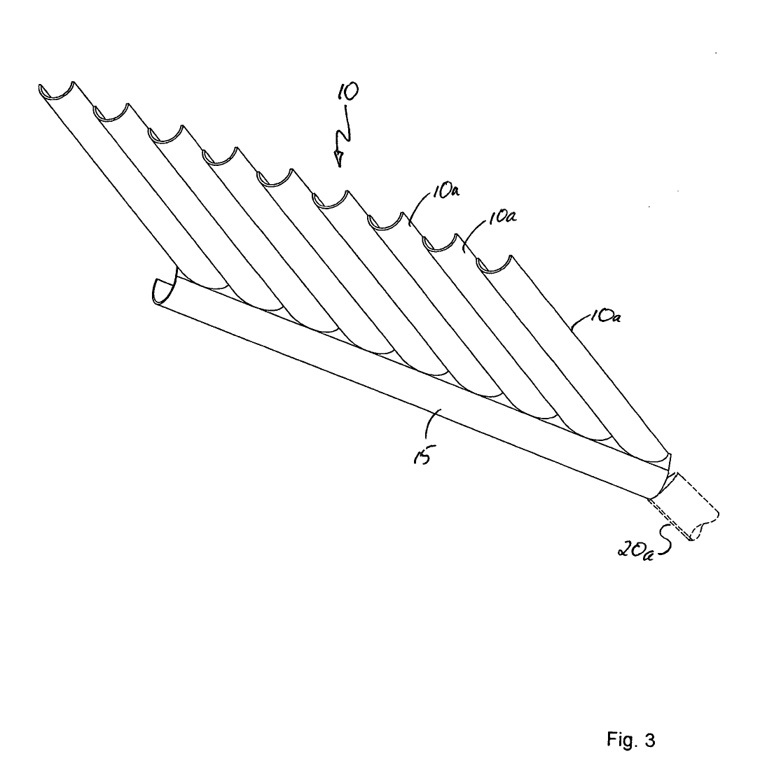

FIG. 4 is a diagrammatic plan view of an alternative embodiment of the present invention.

### DETAILED DESCRIPTION OF EMBODIMENTS OF THE INVENTION

As seen in the accompanying figures wherein similar characters of reference denote corresponding parts in each view, the snow collection and transportation system according to one embodiment of the present invention includes a snow collector 10, a snow diverter 15 cooperating with snow collector 10 so as to redirect snow flowing from collector 10, via diverter 15, into snow transportation pipe 20.

Snow collector 10 may be a laterally abutting array of elongate troughs or channels 10b mounted side-by-side to one another so as to provide a continuous collecting surface onto which snow 25 is deposited either for example by snow fall when collector 10 is placed at high altitude onto a mountain-side 30, or by the flow of snow down mountain-side 30 so as to cover collector 10. Snow 25 in collector 10 slides in direction A along channels 10b urged by gravity for example when collector 10 is positioned on mountain-side 30 so as to have a slope of for example thirty degrees or more. Fasteners such as spikes (not shown) may be employed to securely mount collector 10 to mountain-side 30.

Snow 25 is assisted in sliding in direction A so as to be caught by and in the trough of snow diverter 15 if channels 10b are made of a material having a low coefficient of friction, for example, if channels 10b are made of plastic, PVC or other material known in the art to have a low coefficient of friction at low temperature. Snow diverter 15 may be made of the same or similar material and is disposed generally perpendicular or at an acute angle to flow direction A so as to provide a catchment for snow 25 exiting the bottom ends of channels 10b so as to thereby direct the snow in direction B. Diverter 15 advantageously is also inclined downwardly from an upper end 15a to a lower end 15b cooperating with an upper end 20a of snow transportation pipe 20.

Advantageously, lower end 15b of snow diverter 15 is coupled to the opening at upper end 20a so that snow captured by snow diverter 15 from snow collector 10 flows freely into transportation pipe 20 whereupon the snow entrained into upper end 20a slides in direction C down the downwardly inclined length of transportation pipe 20 so as to be deposited from lower end 20b.

Transportation pipe 20 is illustrated as being a straight pipe. It is not intended that the scope of the present invention be so limited, it being understood that transportation pipe 20 may be straight or curved so long as the snow is free to flow along the length of the pipe without becoming plugged. The inclination of transportation pipe 20 as it travels down hill from the high altitude position of snow collector 10 to the relatively low altitude ski resorts located at the lower end 20b of transportation pipe 20, and assisted again by the use of materials having a low coefficient of friction on the interior of pipe 20, assists snow entrained into upper end 20a to quickly gather velocity. Hence, the mass of the snow results in a corresponding momentum of the flow mass thereby making plugging of pipe 20 unlikely providing the pipe is sufficiently straight and of sufficient size.

In one embodiment, not intended to be limiting, pipe 20, which in alternative embodiments may also be an open or closed flume (herein collectively referred to as a pipe), passes from the high altitude where cold and dry snow collects as drifts onto snow collector 10, through what may be the freezing level, so as to deposit higher density snow having travelled along the length of pipe 20 below the freezing level to the resort in need of snow for spreading onto its runs, etc. Although applicant does not wish to be held to any particular physical theory of operation, it is thought that the entrainment of snow from diverter 15 into the upper end 20a of transportation pipe 20, also entrains a volume of cold air which acts as a lubricant or cushion between the snow and the interior surface of pipe 20 thereby further lowering the coefficient of friction between the snow and the pipe. Again in one embodiment not intended to be limiting, the inside diameter of pipe 20 may be twelve inches (thirty centimeters) and the pipe made of PVC.

To assist in distribution of snow from lower end 20b, the end 20b may be mounted to a plurality of smaller distribution pipes (not shown) which may be rigid or flexible or otherwise pivotally mounted so as to direct snow to advantageous locations on the resort. Lower end 20b may also be moved or angled either left or right to spread the accumulated snow. Wide track grooming machines may then spread the snow pack to varying depths of for example from fifty centimeters to one meter so that the base or snow pack will be better able to withstand mild temperatures. Again in one embodiment not intended to be limiting, the distribution pipe may be located in an area where there is a higher concentration of snow, for example an avalanche area, or an area above the timberline, or out-of-bounds areas. The pipe line could be fed by snow blowers or wind turbulence.

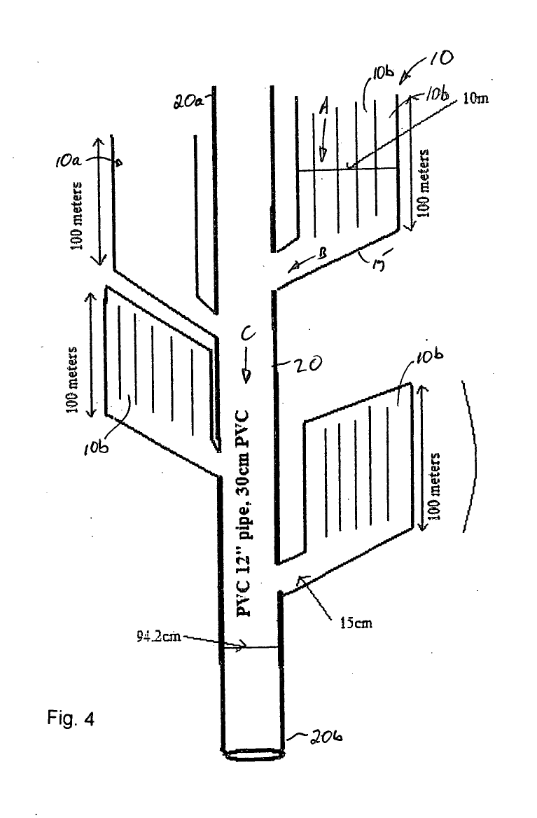

In yet a further embodiment, as seen in FIG. 4, a plurality of snow collectors 10 may be employed to feed into transportation pipe 20 via a corresponding plurality of snow diverters 15 where for example each snow collector 10 may be planar as seen in collector 10a or may employ a plurality of side-by-side troughs or channels 10b each extending for example one hundred meters in length, the laterally abutting array of channels 10b for example extending ten meters measured laterally across the array. In one embodiment, the laterally abutting array of channels 10b may be sheets of corrugated fibreglass or other corrugated material.

As may be seen, the system according to the present invention may efficiently deliver high volumes of snow from high altitude at relatively high velocity for example in the order of fifty to sixty kilometers per hour from the lower end of the transportation pipe by merely relying on the fluid-like qualities of the snow at high altitude and gravity to urge the snow into higher density mass and for transportation thereby assisting or replacing conventional snow making equipment.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method for collecting and transporting snow comprising the steps of:
a) providing a snow collector mounted to an inclined alpine mountain-side and a pipe cooperating with said snow collector to remove snow from said snow collector to a downhill location remote from said snow collector,
b) collecting snow in said snow collector and diverting snow from said snow collector into said pipe,
c) transporting the snow downhill in said pipe,
d) delivering the snow from said pipe at said downhill location below the elevation of said snow collector.

2. The method of claim 1 wherein said snow collector has a substantially planar snow collecting catchment surface, the method further comprising the step of mounting said snow collector to an alpine mountainside so that said snow collecting catchment surface is inclined, thereby urging snow collecting on said catchment surface towards a downhill side of said catchment surface, and providing a snow diverter cooperating with said downhill side of said snow collector to divert the snow from the downhill side into the pipe.

3. The method of claim 1 further comprising the steps of providing a corrugated-shaped surface as said catchment surface and aligning channels of said corrugated-shaped surface so as to be elongate in a substantially downhill direction towards said snow diverter.

4. The method of claim 3 further comprising the step of providing a plurality of said snow collectors spaced apart along, and cooperating with an upper end of said pipe.

5. The method of claim 4 further comprising the step of providing said plurality of said snow collectors on opposite sides of said pipe.

6. The method of claim 3 wherein said snow diverter includes a trough and wherein said method includes the step of aligning said trough substantially laterally across lowermost ends of said channels and inclining said trough downwardly into a downhill inclination so as to register, in fluid communication therewith, a lowermost end of said trough with an upper end of said pipe.

7. The method of claim 6 further comprising the step of angling said trough relative to said channels so as to increase said downhill inclination of said trough.

8. A apparatus for collecting and transporting snow comprising:
a) a snow collector for mounting to an inclined alpine mountain-side and a pipe for mounting so that an upper end thereof is adjacent to, so as to cooperate with, said snow collector to remove snow sliding from said snow collector to a downhill location remote from said snow collector,
b) a snow diverter mounted to said snow collector for diverting snow from said snow collector into said pipe,
wherein said pipe transports the snow downhill from said snow collector in said pipe so as to deliver the snow from said pipe at said downhill location below the elevation of said snow collector.

9. The apparatus of claim 8 wherein said snow collector has a substantially planar snow collecting catchment surface mountable to an alpine mountainside so that said snow collecting catchment surface is inclined, whereby snow collecting on said catchment surface is urged by gravity towards a downhill side of said catchment surface so as to be captured by said snow diverter cooperating with said downhill side of said snow collector to divert the snow from the downhill side into the pipe.

10. The apparatus of claim 1 further comprising a corrugated-shaped surface catchment surface mountable so as to align channels of said corrugated-shaped surface to be elongate in a substantially downhill direction towards said snow diverter.

11. The apparatus of claim 1 further comprising a plurality of said snow collectors and cooperating said snow diverters spaced apart along, and cooperating with said upper end of said pipe.

12. The apparatus of claim 11 wherein said plurality of said snow collectors are disposed on opposite sides of said pipe.

13. The apparatus of claim 3 wherein said snow diverter includes a trough.

14. The apparatus of claim 13 wherein said trough is aligned substantially laterally across a lowermost end of said snow collector and, when mounted to said mountain-side, is inclined downwardly in a downhill inclination so as to register, in fluid communication therewith, a lowermost end of said trough with an upper end of said pipe.

15. The apparatus of claim 14 wherein said trough is angled relative to said snow collector so as to increase said downhill inclination of said trough.
